(19) United States
(12) Patent Application Publication
(10) Pub. No.: US 2024/0239354 A1
(43) Pub. Date: Jul. 18, 2024

(54) INFORMATION PROCESSING SYSTEM AND INFORMATION PROCESSING METHOD

(71) Applicant: Panasonic Intellectual Property Management Co., Ltd., Osaka (JP)

(72) Inventors: Takayoshi ITO, Osaka (JP); Kaoru YOKOTA, Hyogo (JP); Akihito TAKEUCHI, Osaka (JP)

(73) Assignee: Panasonic Intellectual Property Management Co., Ltd., Osaka (JP)

(21) Appl. No.: 18/405,519

(22) Filed: Jan. 5, 2024

(30) Foreign Application Priority Data
Jan. 18, 2023 (JP) 2023-005580

(51) Int. Cl. B60W 50/00

(52) U.S. Cl. CPC B60W 50/0097; B60W 2556/20; B60W 2756/00

(57) ABSTRACT

An information processing system includes a pre-processor that obtains input data; a model processor that obtains output data by inputting the input data to part of a machine learning model, and outputs the output data; and a post-processor which obtains the output data from the model processor, and executes post-processing using the output data. The model processor obtains data indicating a feature as the output data, the data being data output from the part of the machine learning model for the input data and being obtained in the middle of the prediction performed by the data. The post-processor identifies the result of the prediction performed by the machine learning model by inputting the output data to a remaining part of the machine learning model, and executes post-processing on the result of the prediction.

### CROSS REFERENCE TO RELATED APPLICATION

The present application is based on and claims priority of Japanese Patent Application No. 2023-005580 filed on Jan. 18, 2023.

### FIELD

The present disclosure relates to an information processing system used in vehicles.

### BACKGROUND

Recently, artificial intelligence (AI), machine learning, and the like have received attention. Unfortunately, systems using machine learning models may be subjected to an attack to steal their machine learning models, that is, a model extraction attack. Non Patent Literature (NPL) 1 discloses a method of suppressing such a model extraction attack.

### CITATION LIST

### Non Patent Literature

NPL 1: “Frontier of Studies of Machine Learning Security”, Ikuya Morikawa, July 2021, Institute of Electronics, Information and Communication Engineers, Engineering Sciences Society Fundamentals Review Vol. 15, No. 1, pp. 37-46

### SUMMARY

However, the method disclosed in NPL 1 can be improved upon.

In view of this, the present disclosure provides an information processing system capable of improving upon the above related art.

The information processing system according to one aspect of the present disclosure is an information processing system provided in a vehicle, the information processing system including: a pre-processing processor that obtains input data indicating a sensing result for at least one of the vehicle, surroundings of the vehicle, or an inside of the vehicle; a model processing processor that obtains output data by inputting the input data to at least part of a machine learning model trained to perform prediction which is predetermined, on the sensing result, and outputs the output data; and a post-processing processor that obtains the output data from the model processing processor, and executes post-processing which is predetermined, using the output data. In a first processing mode, the model processing processor: inputs the input data to the part of the machine learning model; and obtains data indicating a feature as the output data, the data being data output from the part of the machine learning model for the input data and being obtained in a middle of the prediction performed by the machine learning model, and the post-processing processor identifies a result of the prediction performed by the machine learning model by inputting the output data to a remaining part of the machine learning model, and executes the post-processing on the result of the prediction.

These general or specific aspects may be implemented by a system, a method, an integrated circuit, a computer program, or a recording medium such as a computer-readable CD-ROM, or may be implemented by any combination of systems, methods, integrated circuits, computer programs, and recording media. The recording medium may be a non-transitory recording medium.

The information processing system according to the present disclosure is capable of improving upon the above related art.

Further advantages and/or effects in one aspect according to the present disclosure will be clarified from the specification and its accompanying drawings. Although such advantages and/or effects are provided by the configurations described in an embodiment and the specification and its accompanying drawings, not all of the configurations are always needed.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a drawing for illustrating a model extraction attack.

FIG. 2 is a drawing for illustrating an existing countermeasure taken against the model extraction attack.

FIG. 3 is a drawing for illustrating another existing countermeasure taken against the model extraction attack.

FIG. 4 is a drawing for illustrating the point of view in the present disclosure which also enables suppression in model extraction attack against an integrated device.

FIG. 5 is a diagram illustrating an overall configuration of the information processing system according to an embodiment.

FIG. 6 is a drawing for illustrating a first processing mode according to the embodiment.

FIG. 7 is a drawing for illustrating a second processing mode according to the embodiment.

FIG. 8 is a drawing for illustrating a third processing mode according to the embodiment.

FIG. 9 is a drawing for illustrating a modification of the third processing mode according to the embodiment.

FIG. 10 is a drawing for illustrating a fourth processing mode according to the embodiment.

FIG. 11 is a drawing for illustrating a modification of the fourth processing mode according to the embodiment.

### DESCRIPTION OF EMBODIMENT

### (Underlying Knowledge Forming Basis of the Present Disclosure)

The present inventor has found that the method disclosed in NPL 1 described in “Background” has the following problem.

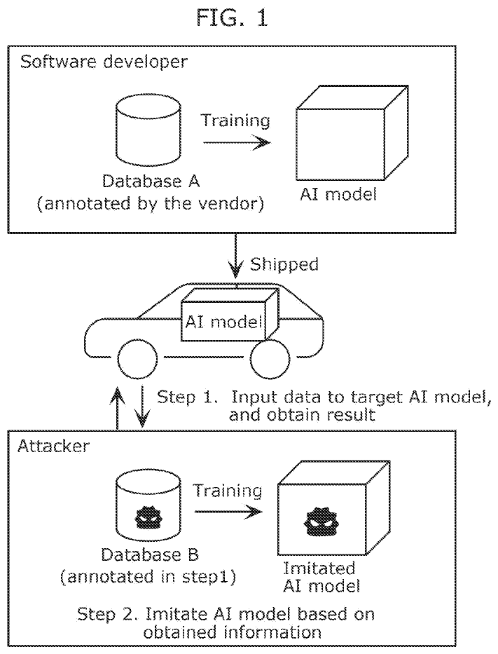

FIG. 1 is a drawing for illustrating a model extraction attack.

For example, as illustrated in FIG. 1, a software developer creates an AI model (specifically, machine learning model) by training using database A. Database A stores a data set, and the data set includes a large quantity of pieces of learning data and pieces of correct answer data (i.e., supervisor data) corresponding to those of learning data. The AI model is shipped, and is provided in a vehicle. On the other hand, an attacker inputs pieces of input data included in database B to the AI model provided in the vehicle, thereby obtaining obtained information indicating the result of the prediction performed by the AI model for those pieces of input data. In other words, the attacker obtains the obtained information corresponding to each of the pieces of input data as the correct answer data for the input data. The attacker then associates the correct answer data with the input data, and stores the correct answer data in database B. Thereby, a data set for creating an AI model is prepared. The attacker then creates an AI model by training using the data set stored in database B. It can be said that the AI model thus created by the attacker is a fraudulent AI model which imitates the authentic AI model created by the software developer. Such an attack against the authentic AI model by the attacker is called model extraction attack. The authentic AI model is stolen by such a model extraction attack.

Here, creation of the AI model needs all of tasks of obtaining of training data, annotation, and model tuning. However, the above-mentioned attacker can create the AI model using the model extraction attack without performing annotation. The annotation requires a large quantity of manpower work and thus huge cost. Accordingly, using the above-mentioned model extraction attack, the attacker can simply imitate the AI model at low cost. Imitation or stealing of the authentic AI model increases a possibility that the authentic AI model will be attacked by another attack against such as a hostile attack against safety.

By taking a countermeasure which obstructs such a model extraction attack, it can reduce merits and motivation of the attacker, thus reducing risks that the AI model will be attacked.

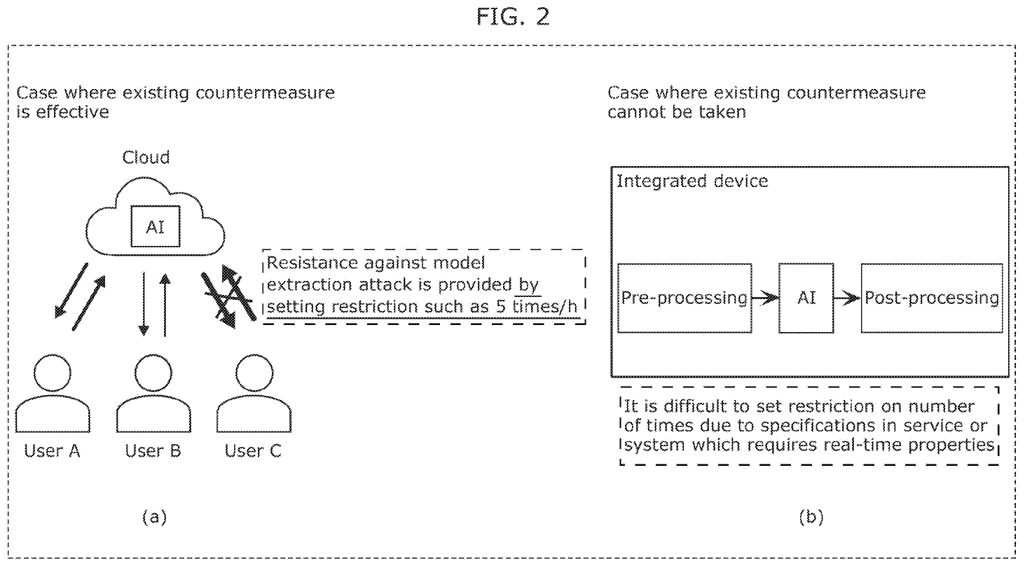

FIG. 2 is a drawing for illustrating an existing countermeasure taken against the model extraction attack. The existing countermeasure illustrated in FIG. 2 is one example of the method disclosed in NPL 1.

In the existing countermeasure taken against the model extraction attack, in a system which can obtain the result of the prediction performed by the AI model for the input data in response to a request from an application programming interface (API), the number of times of request of users transmitted from the API is restricted. For example, as illustrated in (a) of FIG. 2, the number of times of request is restricted to 5 times per hour. For the attacker who is user C to prepare a data set, several thousands to several ten thousands times of request are needed, and as a result, the model extraction attack needs a large amount of time. This reduces the motivation of user C for the model extraction attack, thus suppressing the model extraction attack.

Although such an existing countermeasure is effective when the AI model is in a cloud as illustrated in (a) of FIG. 2, however, a sufficient effect is difficult to obtain in an integrated device illustrated in (b) of FIG. 2. The integrated device is a device that performs pre-processing, processing using the AI model, and post-processing, and is provided in a vehicle, for example. The pre-processing is image capturing with a camera, for example. The processing using the AI model is recognition of an object captured in the image obtained by image capturing. The post-processing is processing such as warning to the object recognized. Such an integrated device provided in the vehicle requires real-time properties in some cases, and thus it is difficult to restrict the number of times of request.

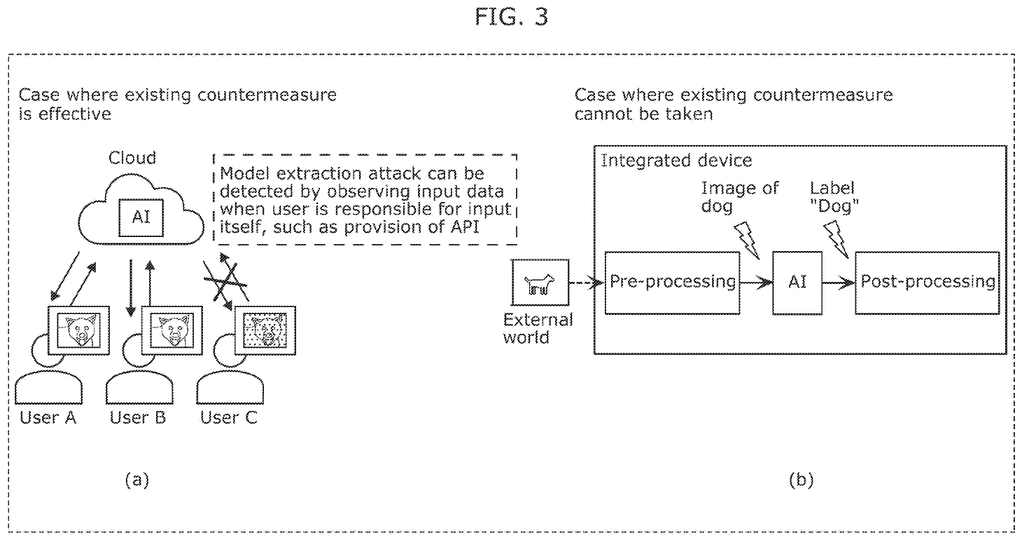

FIG. 3 is a drawing for illustrating another existing countermeasure taken against the model extraction attack. The existing countermeasure illustrated in FIG. 3 is another method disclosed in NPL 1.

In the another existing countermeasure taken against the model extraction attack, the model extraction attack is detected based on the data distribution of the input data. For example, as illustrated in (a) of FIG. 3, user C who is the attacker tries to generate input data lacking in his data set, and tries to input the input data to the AI model using the API. As a result, distributions of pieces of input data input to the AI model by users A and B who are not the attacker, respectively, are different from that of pieces of input data input to the AI model by user C, who is the attacker, for the model extraction attack. Thus, the model extraction attack can be suppressed by detecting the model extraction attack based on the data distribution.

Although such an existing countermeasure is effective when the AI model is in a cloud as illustrated in (a) of FIG. 3 and each user is responsible for the input data, however, a sufficient effect is difficult to obtain in the integrated device illustrated in (b) of FIG. 3. In such an integrated device, the input data input to the AI model is the data output by the pre-processing, and the user is not responsible for the input data. For example, when an image of a dog is captured in the pre-processing, an image showing a dog is input to the AI model as the input data. Then, a label indicating “Dog” is output from the AI model, and is used in the post-processing. The attacker can obtain such input data by tapping, and need not take the trouble to generate the input data and input the input data to the AI model. Furthermore, the attacker also can obtain the result of the prediction performed by the AI model, that is, the label by tapping. For this reason, the above-mentioned existing countermeasure cannot be applied to the model extraction attack in the integrated device.

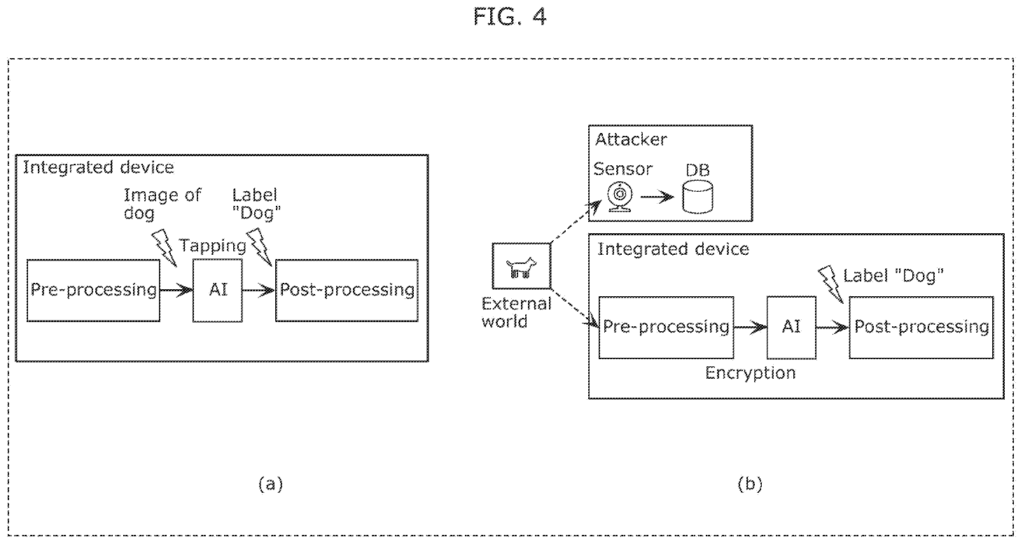

FIG. 4 is a drawing for illustrating the point of view of the present disclosure which also enables suppression in model extraction attack against the integrated device.

As illustrated in (a) of FIG. 4, the attacker obtains a data set by obtaining the input data to the AI model (for example, image data of a dog) and the output data from the AI model (for example, a label indicating the dog) by tapping. Thus, if at least one of the input data or the output data can be hidden, the model extraction attack can be suppressed. However, it is difficult to hide the input data. For example, encryption of the input data output by the pre-processing and input to the AI model is considered. However, even if the input data is encrypted, the attacker can obtain the input data by using a sensor as illustrated in (b) of FIG. 4. In other words, in the pre-processing in the integrated device, the input data which is an image obtained by capturing an external world is encrypted and output. By using a sensor which captures the same external world, the attacker can obtain input data identical or similar to the input data output by the pre-processing. Therefore, encryption of the input data is meaningless.

Thus, the present discloser has noticed that hiding of the output data rather than the input data is more important to suppress the model extraction attack. In other words, the present discloser has found that even in a system such as an integrated device provided in a vehicle, the model extraction attack can be effectively suppressed by hiding the result of the prediction performed by the AI model corresponding to the input data.

Specifically, the information processing system according to a first aspect of the present disclosure is an information processing system provided in a vehicle, the information processing system including: a pre-processing processor that obtains input data indicating a sensing result for at least one of the vehicle, surroundings of the vehicle, or an inside of the vehicle; a model processing processor that obtains output data by inputting the input data to at least part of a machine learning model trained to perform prediction which is predetermined, on the sensing result, and outputs the output data; and a post-processing processor that obtains the output data from the model processing processor, and executes post-processing which is predetermined, using the output data. In a first processing mode, the model processing processor: inputs the input data to the part of the machine learning model; and obtains data indicating a feature as the output data, the data being data output from the part of the machine learning model for the input data and being obtained in a middle of the prediction performed by the machine learning model, and the post-processing processor identifies a result of the prediction performed by the machine learning model by inputting the output data to a remaining part of the machine learning model, and executes the post-processing on the result of the prediction.

Thereby, in the first processing mode, the output data indicating a feature is output from the model processor to the post-processor. Thus, the output data does not indicate the result of the prediction performed by the machine learning model, and therefore the result of the prediction is hidden. This can make it difficult for the attacker to read the result of the prediction even when the output data is stolen by an attacker by tapping. As a result, the model extraction attack can be effectively suppressed. In other words, although the model extraction attack can be suppressed by the method disclosed in NPL 1 when the system is present in a cloud or the like, it is difficult to effectively use the method when the system is presented in the vehicle. However, the information processing system according to the first aspect of the present disclosure can effectively suppress the attack against the machine learning model.

In the information processing system according to a second aspect subordinate to the first aspect, in a second processing mode, when pieces of input data each of which is the input data are obtained by the pre-processing processor, the model processing processor may input the pieces of input data to the machine learning model; may identify results of the prediction performed by the machine learning model for the pieces of input data; and may obtain pieces of output data each of which is the output data, by executing labeling on the results of the prediction according to a predetermined rule, in obtaining the pieces of output data, when identical results of the prediction are identified for the pieces of input data, the model processing processor may obtain the pieces of output data indicating different labels by executing the labeling on the identical results of the prediction, and the post-processing processor may identify the identical results of the prediction by executing decoding according to the predetermined rule on the pieces of output data having different labels, and may execute the post-processing on the identical results of the prediction.

Thereby, in the second processing mode, pieces of output data indicating different labels, but not pieces of output data always indicating the same label, for the identical results of the prediction repeatedly identified are output from the model processor to the post-processor. In other words, when the identical results of the prediction are repeatedly identified, the labels indicated by the pieces of output data sequentially output are successively changed to hide the results of the prediction. For example, the labels are redundant. Thus, this can make it difficult for the attacker to read the results of the prediction even when these pieces of output data are stolen by the attacker by tapping. As a result, the model extraction attack can be effectively suppressed.

In the information processing system according to a third aspect subordinate to the first aspect or the second aspect, in a third processing mode, when pieces of input data obtained by the pre-processing processor are sequentially input to the model processing processor, the model processing processor: may input the pieces of input data to the machine learning model; may identify results of the prediction performed by the machine learning model for the pieces of input data; and may output pieces of output data corresponding to the pieces of input data and indicating the results of the prediction to the post-processing processor in an order different from an input order of the pieces of input data input to the model processing processor.

Thereby, in the third processing mode, the pieces of output data corresponding to the pieces of input data are output in an order different from the input order of the pieces of input data input to the model processor. Accordingly, even when the attacker steals these pieces of output data by tapping, the attacker cannot easily grasp combinations of pieces of input data and pieces of output data corresponding to the pieces of input data. In short, the results of the prediction performed by the machine learning model for the pieces of input data are hidden. As a result, the model extraction attack can be effectively suppressed.

In the information processing system according to a fourth aspect subordinated to any one of the first to third aspects, in a fourth processing mode, when N pieces of input data are obtained by the pre-processing processor, and are input to the model processing processor, where N is an integer of 2 or greater, the model processing processor: may identify results of the prediction performed by the machine learning model for M pieces of input data among the N pieces of input data, where M is an integer of 1 or greater and N or smaller; and may obtain and outputs one piece of output data based on M results of the prediction.

Thereby, in the fourth processing mode, the number of pieces of input data input to the model processor is different from that of pieces of output data output from the model processor. Accordingly, even when these pieces of output data are stolen by the attacker by tapping, the attacker cannot easily grasp combinations of pieces of input data and pieces of output data corresponding to the pieces of input data. In short, the results of the prediction performed by the machine learning model for the pieces of input data are hidden. As a result, the model extraction attack can be effectively suppressed.

Hereinafter, an embodiment will be specifically described with reference to the drawings.

The embodiment described below all illustrates general or specific examples. Numeric values, shapes, materials, components, arrangement positions of components and connection forms thereof, steps, order of steps, and the like shown in the embodiment are exemplary, and should not be construed as limitations to the present disclosure. Among the components according to the embodiment below, the components not described in an independent claim representing the most superordinate concept of the present disclosure are described as optional components.

The drawings are schematic views, and are not necessarily precise illustrations. In the drawings, identical referential signs are given to identical constituent components.

### Embodiment

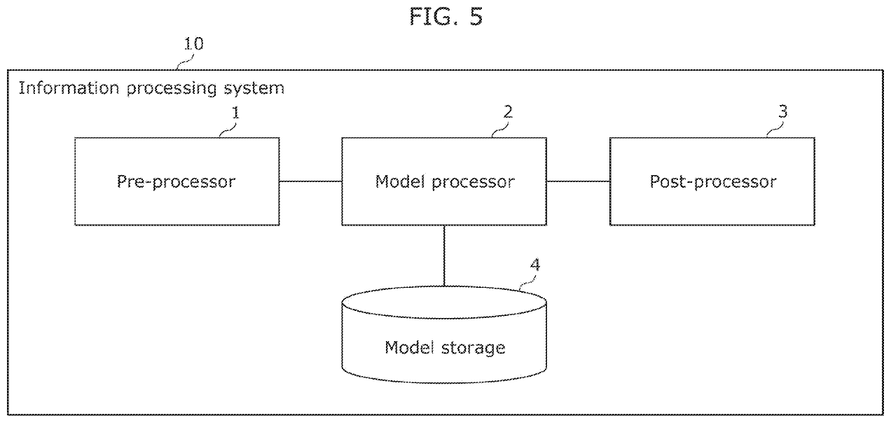

FIG. 5 is a diagram illustrating an overall configuration of the entire information processing system according to the present embodiment.

Information processing system 10 according to the present embodiment is a system provided in a vehicle, and includes pre-processor 1, model processor 2, post-processor 3, and model storage 4. It can also be said that information processing system 10 is an integrated device.

Pre-processor 1 obtains input data indicating a sensing result of at least one of the vehicle, surroundings of the vehicle, or an inside of the vehicle. Such pre-processor 1 may be a sensor that detects the surroundings of the vehicle. In a specific example, pre-processor 1 is a camera. Specifically, pre-processor 1 obtains image data by capturing an image of the surroundings of the vehicle, and outputs the image data as input data to model processor 2. Pre-processor 1 may be a sensor different from a camera. Specifically, pre-processor 1 may be a light detection and ranging (LiDAR) distance sensor, a time-of-flight (ToF) distance sensor, or a touch panel. Alternatively, pre-processor 1 may be a camera that captures an image of a passenger present inside the vehicle, or may be a sensor that monitors the traveling operation of the vehicle.

Model storage 4 is a recording medium which stores a trained machine learning model. The machine learning model is preliminarily trained to perform prediction predetermined on the sensing result. The sensing result is indicated by the input data output from pre-processor 1. Specifically, when the input data is an image data, the machine learning model is preliminarily trained to output a result of the prediction indicating the type of an object shown in the image data for the input of the image data. In other words, the machine learning model is trained to output a result of recognition of an object for the image data as the result of the prediction. The machine learning model may be a neural network, or may be any model such as random forest, logistic regression, clustering, principal component analysis, or a statistical model.

Model processor 2 obtains the input data output from pre-processor 1, and obtains output data by inputting the input data to at least part of the machine learning model stored in model storage 4. Then, model processor 2 outputs the output data to post-processor 3.

Post-processor 3 obtains the output data from model processor 2, and executes predetermined post-processing using the output data. The post-processing is, for example, processing performed on the result of recognition of the image to implement advanced driver-assistance systems (ADAS). For example, the post-processing may be processing that informs a driver of the vehicle of a pedestrian or a road sign ahead of the vehicle, or may be processing that controls the speed or steering angle of the vehicle.

Model processor 2 communicates with pre-processor 1 and post-processor 3 through a signal line, for example. As a result, the input data is input or transmitted from pre-processor 1 to model processor 2, and the output data is output or transmitted from model processor 2 to post-processor 3. Pre-processor 1, model processor 2, and post-processor 3 may be configured as individual chips, or may be configured as individual electronic control units (ECUs).

Such information processing system 10 according to the present embodiment operates according to any one of four processing modes or a combination thereof, for example. The four processing modes are a first processing mode, a second processing mode, a third processing mode, and a fourth processing mode.

### [First Processing Mode]

The first processing mode is also called a feature method. In this first processing mode, model processor 2 inputs the input data to part of the machine learning model, and obtains data indicating a feature as the output data, the data being data output from the part of the machine learning model for the input data and being obtained in the middle of the prediction performed by the machine learning model. Post-processor 3 identifies the result of the prediction performed by the machine learning model by inputting the output data to the remaining part of the machine learning model, and executes the post-processing on the result of the prediction.

In other words, without performing the entire arithmetic processing by the machine learning model, model processor 2 obtains the data indicating the feature as the output data, the data being output in the middle of the arithmetic processing, and outputs the data to post-processor 3. Post-processor 3 executes a remaining part of the arithmetic processing by the machine learning model using the output data. Thus, model processor 2 uses the part present at a former stage of the machine learning model stored in model storage 4, and post-processor 3 uses the remaining part present at a latter stage of the machine learning model stored in model storage 4.

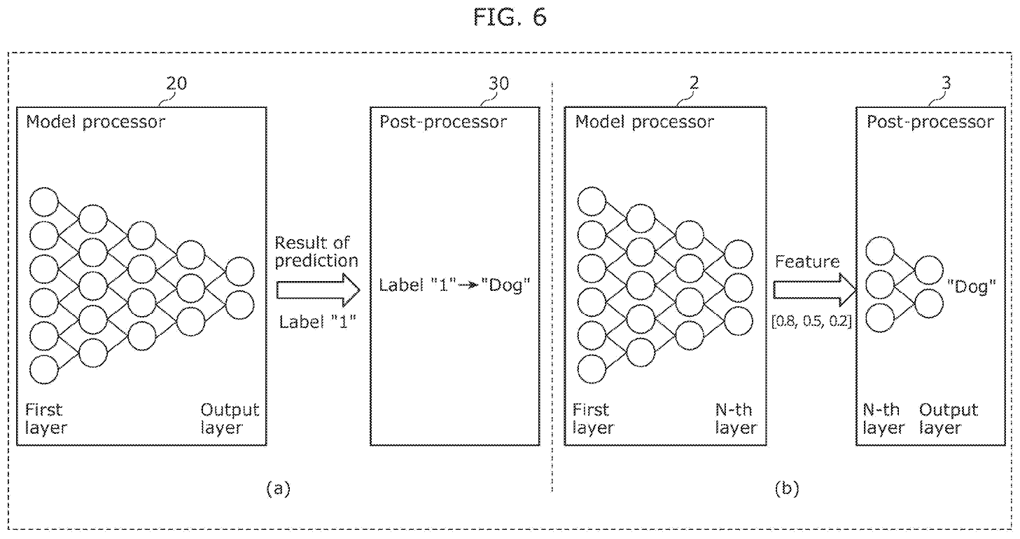

FIG. 6 is a drawing for illustrating the first processing mode. To be noted, (b) of FIG. 6 illustrates one example of the processing operation of model processor 2 and post-processor 3 in the first processing mode. (a) of FIG. 6 is Comparative Example to the first processing mode, and illustrates one example of a processing operation of a system different from information processing system 10 according to the present embodiment.

For example, in Comparative Example in (a) of FIG. 6, model processor 20 uses all the machine learning model configured of a neural network for the input data. In other words, all the layers from an input layer (a first layer) of the machine learning model to an output layer thereof are used for the input data. Model processor 20 outputs the output data to post-processor 30, the output data being output from the output layer of the machine learning model. When the input data is an image data, model processor 20 outputs output data indicating a label “1” to post-processor 30 as the result of the prediction of object recognition by the machine learning model for the image data. After obtaining the output data, post-processor 30 determines, based on the label “1” indicated by the output data, that the image data shows an object “Dog”, and executes post-processing on the object “Dog”.

However, the output data directly shows the result of the prediction performed by the machine learning model, which is easy for people to understand. Although the result of the prediction is a result of object recognition in the above-mentioned example, it may be a result of classification of the object shown in the image data, or may be a result of segmentation.

In contrast, in the first processing mode of information processing system 10 according to the present embodiment, as illustrated in (b) of FIG. 6, output data indicating a feature which is difficult for people to read is output from model processor 2 to post-processor 3.

Specifically, model processor 2 uses, as the part of the machine learning model, the input layer (first layer) of the machine learning model to the N-th layer thereof for the input data. The N-th layer is an intermediate layer. In other words, model processor 2 inputs the input data to the input layer of the machine learning model, and obtains the data indicating a feature as the output data, the data being output from the N-th layer of the machine learning model. Here, when a plurality of features are output from the N-th layer, data indicating a vector composed of the plurality of features, such as a vector [0.8, 0.5, 0.2], is obtained as the output data. These features are numeric values obtained in the middle of prediction performed by the machine learning model. The output data indicating such (a) feature(s) is output from model processor 2 to post-processor 3.

After obtaining the output data from model processor 2, post-processor 3 uses the N-th layer of the machine learning model to the output layer thereof as the remaining part of the machine learning model for the output data. In other words, post-processor 3 obtains the data output from the output layer by inputting the output data to the N-th layer. This data indicates the result of the prediction of object recognition by the machine learning model for the image data, that is, an object “Dog”. Accordingly, post-processor 3 identifies the object “Dog” as the result of the prediction, and executes the post-processing on the object “Dog”.

Thus, in the first processing mode, the output data indicating the feature is output from model processor 2 to post-processor 3. Accordingly, because the output data does not indicate the result of the prediction performed by the machine learning model, the result of the prediction is hidden. This can make it difficult for the attacker to read the result of the prediction, even when the output data is stolen by the attacker by tapping. As a result, the model extraction attack can be effectively suppressed.

Although the data output from the intermediate layer of the machine learning model is used as the output data output from post-processor 3 in the above-mentioned example, the data output from the output layer may be used as the output data. In this case, after obtaining the input data from pre-processor 1, model processor 2 performs conversion processing on the input data, and inputs the input data subjected to the conversion processing to the input layer of the machine learning model. Then, model processor 2 obtains the data output from the output layer of the machine learning model as the output data, and outputs the output data to post-processor 3. Post-processor 3 identifies the result of the prediction performed by the machine learning model by performing inverse conversion processing on the output data.

For example, when the input data is image data, model processor 2 converts the image data from space domain data to space frequency domain data by performing Fourier transform on the image data. Model processor 2 obtains the space frequency domain data output from the output layer of the machine learning model as the output data by inputting the space frequency domain data to the input layer of the machine learning model. Unlike the data output from the machine learning model for the input of the space domain data, such output data is data which is difficult for people to read. Model processor 2 outputs the output data to post-processor 3. Post-processor 3 inversely converts the output data from the space frequency domain data to the space domain data by performing inverse Fourier transform on the output data. This data indicates the result of the prediction of object recognition for the image data, that is, the object “Dog”. Accordingly, post-processor 3 identifies the object “Dog” as the result of the prediction, and executes the post-processing on the object “Dog”.

Thus, even when conversion processing on the input data and inverse conversion processing on the output data are performed, the output data can be obtained as the data which is difficult for people to read, namely, the result of the prediction can be hidden. As a result, the model extraction attack can be effectively suppressed. The above-mentioned Fourier transform and inverse Fourier transform are one examples of the conversion processing and the inverse conversion processing, and the present disclosure is not limited by these conversions.

### [Second Processing Mode]

The second processing mode is also called a label successive change method. In this second processing mode, every time when an identical result of the prediction performed by the machine learning model is obtained, the label indicated by the output data output from model processor 2 to post-processor 3 is successively changed. Specifically, in this second processing mode, when pieces of input data are obtained by pre-processor 1, model processor 2 inputs the pieces of input data to the machine learning model. Then, model processor 2 identifies the results of the prediction performed by the machine learning model for the pieces of input data, and obtains pieces of output data by executing labeling on the results of the prediction according to a predetermined rule. When the identical results of the prediction are identified for the pieces of input data, model processor 2 obtains pieces of output data indicating different labels by executing the labeling on the identical results of the prediction. Post-processor 3 identifies the identical results of the prediction by executing decoding on the pieces of output data indicating different labels according to the above-mentioned predetermined rule, and executes the post-processing on the identical results of the prediction.

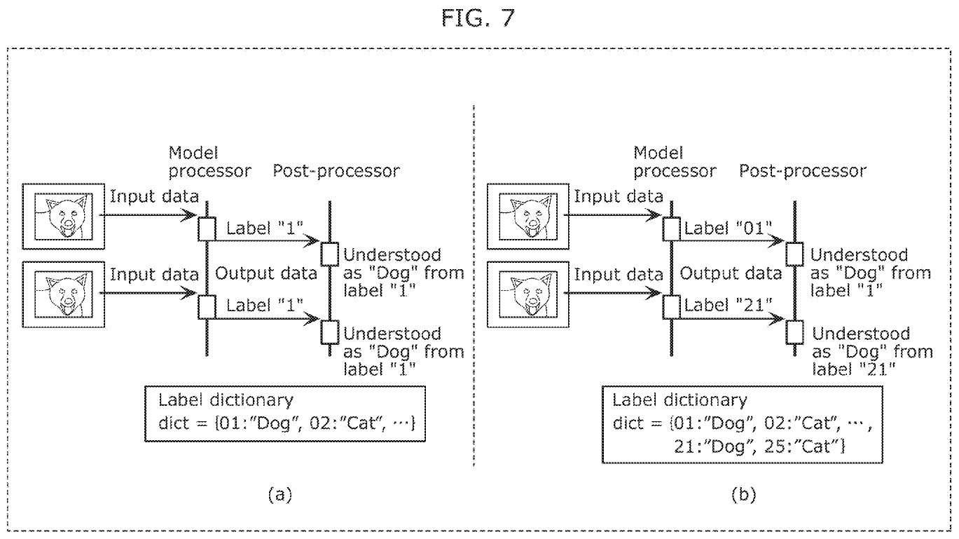

FIG. 7 is a drawing for illustrating the second processing mode. 5(b) of FIG. 7 illustrates one example of the processing operation of model processor 2 and post-processor 3 in the second processing mode. (a) of FIG. 7 is Comparative Example to the second processing mode, and illustrates one example of the processing operation of a system different from information processing system 10 according to the present embodiment.

In Comparative Example illustrated in (a) of FIG. 7, after obtaining input data which is image data showing a dog, a model processor outputs output data for the input data to the post-processor, the output data indicating the result of the prediction of object recognition by the machine learning model. The output data indicates a label “1”, for example. Based on the label “1” indicated by the output data and a label dictionary, the post-processor identifies the result of the prediction of object recognition, that is, identifies the object shown in the image data as “Dog”. The label dictionary indicates the types of objects in association with labels. Next, after obtaining input data which is image data showing a dog as in the previous time, the model processor outputs output data for the input data to the post-processor, the output data indicating the result of the prediction of object recognition by the machine learning model. The output data also indicates the label “1”. Thus, when the output data always indicating the label “1” is output for each of pieces of image data, the attacker can easily predict the result of the prediction performed by the machine learning model by stealing the output data by tapping.

In contrast, in the second processing mode of information processing system 10 according to the present embodiment, as illustrated in (b) of FIG. 7, pieces of output data having different labels, that is, pieces of output data having redundancy are output from model processor 2 to post-processor 3.

Specifically, as illustrated in (b) of FIG. 7, model processor 2 obtains pieces of output data having redundancy by a label increasing method. For example, model processor 2 uses a label dictionary, as the above-mentioned predetermined rule, in which different labels are associated with the type of the same object. In a specific example, in the label dictionary, labels “01” and “21” are indicated in association with an object “Dog”, and labels “02” and “25” are indicated in association with an object “Cat”. Such a label dictionary and labels are redundant. After obtaining input data which is image data showing a dog, model processor 2 identifies an object “Dog” as the result of the prediction of object recognition for the input data by the machine learning model. Model processor 2 performs labeling on the result of the prediction. Specifically, model processor 2 refers to the label dictionary, and selects the label “01” among the labels “01” and “21” associated with the object “Dog” in the label dictionary. Then, model processor 2 obtains the output data indicating the label “01”, and outputs the output data to post-processor 3. After obtaining the output data, post-processor 3 executes decoding on the output data. Specifically, post-processor 3 refers to the label dictionary, and identifies the object “Dog” associated with the label “01” in the label dictionary as the result of the prediction performed by the machine learning model, where the label “01” is indicated by the output data.

Next, after obtaining input data which is image data showing a dog as in the previous time, model processor 2 identifies an object “Dog” as the result of the prediction of object recognition for the input data by the machine learning model. Model processor 2 performs the labeling on the result of the prediction. Specifically, model processor 2 refers to the label dictionary, and selects a label “21” different from the previous label “01” among the labels “01” and “21” associated with the object “Dog” in the label dictionary. Then, model processor 2 obtains output data indicating the label “21”, and outputs the output data to post-processor 3. After obtaining the output data, post-processor 3 executes the decoding on the output data. Specifically, post-processor 3 refers to the label dictionary, and selects the object “Dog” associated with the label “21” in the label dictionary as the same result of the prediction performed by the machine learning model as described above, where the label “21” is indicated by the output data.

Accordingly, in the second processing mode, pieces of output data always indicating the same label for pieces of image data showing a dog are not output. In short, in the second processing mode, pieces of output data having different labels but not pieces of output data always indicating the same label for identical results of the prediction repeatedly identified are output from model processor 2 to post-processor 3. In other words, when identical results of the prediction are repeatedly identified, the labels indicated by pieces of output data sequentially output are successively changed to hide the results of the prediction. This can make it difficult for the attacker to read the result of the prediction even when the attacker steals these pieces of output data by tapping. As a result, the model extraction attack can be effectively suppressed.

In the second processing mode, pieces of output data indicating the same label may be output as long as pieces of output data indicating at least two different labels are output for the identical results of the prediction repeatedly identified. Even in such a case, pieces of output data always indicating the same label for the identical results of the prediction repeatedly identified are not output, and therefore, the above-mentioned effect can be achieved.

Here, besides the label increasing method described above, the second processing mode includes a timestamp method, a random value method, a timestamp label increasing method, and a random value label increasing method.

### <Time Stamp Method>

In the timestamp method, a label dictionary is used in which labels are one-to-one associated with types of objects. For example, the label dictionary is label dictionary d1: {01: “Dog”, 02: “Cat”, . . . }.

In the labeling, using label dictionary d1 described above, model processor 2 determines the initial label for the result of the prediction performed by the machine learning model, and encrypts the label. The encryption of the label uses time information indicating the current time (e.g., hh hours, mm minutes, ss seconds). Specifically, when the initial label is r1, model processor 2 generates encrypted label r2 from “r2=r1×hh+a×mm+ss”. Then, model processor 2 outputs the output data indicating encrypted label r2 to post-processor 3.

After obtaining the output data, using the above-mentioned time information, post-processor 3 performs the decoding on encrypted label r2 indicated in the output data. Because there is almost no time difference between the labeling by model processor 2 and the decoding by post-processor 3, post-processor 3 uses the time information substantially identical to the time information used in model processor 2. Specifically, post-processor 3 obtains initial label r1 from “r1=(r2−a×mm−ss)/hh”. Then, post-processor 3 refers to label dictionary d1, and identifies the type of the object associated with initial label r1 in label dictionary d1 as the result of the prediction performed by the machine learning model.

In such a timestamp method, the above-mentioned predetermined rule is label dictionary d1 and the encryption method of the label. When identical results of the prediction are identified at different times, pieces of output data indicating different encrypted labels are output for the identical results of the prediction, respectively. Accordingly, the same effect as that in the second processing mode can be obtained even in such a timestamp method.

### <Random Value Method>

In the random value method, a label dictionary is used in which labels are one-to-one associated with types of objects. For example, the label dictionary is label dictionary d1: {01: “Dog”, 02: “Cat”, . . . }.

In the labeling, using label dictionary d1 described above, model processor 2 determines the initial label for the result of the prediction performed by the machine learning model, and encrypts the label. The encryption of the label is performed using a random value. Specifically, when the initial label is r1 and the random value is k, model processor 2 generates encrypted label r2 from “r2=pow(r1, k)”. The pow(r1, k) is the function which calculates the k power of r1. Then, model processor 2 outputs the output data indicating encrypted label r2 and random value k to post-processor 3.

After obtaining the output data and random value k, post-processor 3 performs the decoding on encrypted label r2 indicated in output data. Specifically, post-processor 3 obtains initial label r1 from “r1=sqrt(r2, k)”. The sqrt(r2, k) is the function which calculates the k-th root of r2. Then, post-processor 3 refers to label dictionary d1, and identifies the type of the object associated with initial label r1 in label dictionary d1 as the result of the prediction performed by the machine learning model.

In such a random value method, the above-mentioned predetermined rule is label dictionary d1 and the label encryption method. When labels are encrypted using different random values for identical results of the prediction, pieces of output data indicating different encrypted labels are output. Accordingly, the same effect as that in the second processing mode can be obtained even in such a random value method.

### <Label Increasing Method>

The label increasing method is as illustrated in the example in FIG. 7. Specifically, a label dictionary is used in which for each of types of objects, a plurality of labels are associated with the type of the object. For example, the label dictionary is label dictionary d1: {01: “Dog”, 11: “Dog”, 21: “Dog”, 02: “Cat”, 12: “Cat”, 22: “Cat”, . . . }.

In the labeling, model processor 2 selects the label associated with the type of the object from label dictionary d1 described above, the object being the result of the prediction performed by the machine learning model. For example, when model processor 2 identifies the object “Dog” as the result of the prediction performed by the machine learning model, model processor 2 randomly selects any one of labels “01”, “11”, and “21” associated with the object “Dog”. For example, the label “01” is selected. In this case, model processor 2 outputs the output data indicating the label “01” to post-processor 3.

Thereafter, when model processor 2 identifies the object “Dog” again as the result of the prediction performed by the machine learning model, model processor 2 also randomly selects any one of the labels “01”, “11”, and “21” associated with the object “Dog”. For example, the label “11” is selected. In this case, model processor 2 outputs the output data indicating the label “11” to post-processor 3.

After obtaining the output data, post-processor 3 refers to label dictionary d1, and identifies the type of the object associated with the label, which is indicated by the output data, in label dictionary d1 as the result of the prediction performed by the machine learning model.

In such a label increasing method, the above-mentioned predetermined rule is label dictionary d1 having redundancy. Moreover, pieces of output data indicating different labels are output for the identical results of the prediction, respectively. Accordingly, the same effect as that in the second processing mode can be obtained even in such a label increasing method.

### <Timestamp Label Increasing Method>

In the timestamp label increasing method, one label dictionary corresponding to the above-mentioned time information is selected from label dictionaries, and is used. In the label dictionaries, labels are one-to-one associated with types of objects. For example, the label dictionaries include label dictionaries d1, d2, and d3. In a specific example, label dictionary d1 is indicated by d1: {01: “Dog”, 02: “Cat”, . . . }, label dictionary d2 is indicated by d2: {02: “Dog”, 03: “Cat”, . . . }, and label dictionary d3 is indicated by d3: {03: “Dog”, 04: “Cat”, . . . }.

In the labeling, model processor 2 selects one label dictionary corresponding to the time information from label dictionaries d1, d2, and d3. For example, different time zones are assigned to label dictionaries d1, d2, and d3. Model processor 2 selects the label dictionary having the time zone including the time indicated by the time information. Then, model processor 2 selects label dictionary d2, for example, and determines the label “02” for the result of the prediction when the result of the prediction performed by the machine learning model indicates the object “Dog”. Model processor 2 outputs the output data indicating label “02” to post-processor 3.

After obtaining the output data, post-processor 3 selects one label dictionary corresponding to the time information from label dictionaries d1, d2, and d3 as in the case of model processor 2. Because there is almost no time difference between the labeling by model processor 2 and the decoding by post-processor 3, post-processor 3 selects the same label dictionary as that used in model processor 2. In the above-mentioned example, post-processor 3 selects label dictionary d2. Post-processor 3 identifies the type of the object associated with the label “02” in label dictionary d2, that is, the object “Dog” as the result of the prediction performed by the machine learning model, where the label “02” is indicated by the above-mentioned output data.

In such a timestamp label increasing method, the above-mentioned predetermined rule is label dictionaries d1, d2, and d3 having redundancy and the label dictionary selection method. When label dictionaries different from each other are used for identical results of the prediction, respectively, pieces of output data having different labels are output. Accordingly, the same effect as that in the second processing mode can be obtained even in such a timestamp label increasing method.

### <Random Value Label Increasing Method>

In the random value label increasing method, one label dictionary corresponding to the above-mentioned random value is selected from label dictionaries. In the label dictionaries, labels are one-to-one associated with types of objects. For example, the label dictionaries are label dictionaries d1, d2, and d3 as in the timestamp label increasing method, that is, the number of label dictionaries is 3.

In the labeling, model processor 2 selects one label dictionary corresponding to the random value from label dictionaries d1, d2, and d3. For example, numerals 0, 1, and 2 are assigned to label dictionaries d1, d2, and d3, respectively. Model processor 2 selects the label dictionary having a remainder obtained by dividing the random value by the number of label dictionaries (3 in the above example). Specifically, when the random value is 5 and the number of label dictionaries is 3, model processor 2 selects label dictionary d3 having a remainder “2”. Then, model processor 2 determines the label “03” for the result of the prediction when the result of the prediction performed by the machine learning model indicates the object “Dog”. Model processor 2 outputs the output data indicating the label “03” and the random value to post-processor 3.

After obtaining the output data and the random value, post-processor 3 selects one label dictionary corresponding to the random value from label dictionaries d1, d2, and d3 as in model processor 2. In the above-mentioned example, post-processor 3 selects label dictionary d3. Post-processor 3 identifies the type of the object associated with the label “03” in label dictionary d3, that is, the object “Dog” as the result of the prediction performed by the machine learning model, where the label “03” is indicated by the above-mentioned output data.

In such a random value label increasing method, the above-mentioned predetermined rule are label dictionaries d1, d2, and d3 having redundancy and the label dictionary selection method. When label dictionaries different from each other are used for identical results of the prediction, respectively, pieces of output data having different labels are output. Accordingly, the same effect as that in the second processing mode can be obtained even in such a random value label increasing method.

### [Third Processing Mode]

The third processing mode is also called a random processing method. In this third processing mode, the output order of the pieces of output data from model processor 2 is randomly changed. Specifically, when pieces of input data obtained by pre-processor 1 are sequentially input to model processor 2, model processor 2 inputs the pieces of input data to the machine learning model, and identifies the results of the prediction performed by the machine learning model for the pieces of input data. Then, model processor 2 outputs pieces of output data indicating the results of the prediction (which correspond to the pieces of input data) to post-processor 3 in an order different from the input order of the pieces of input data input to model processor 2.

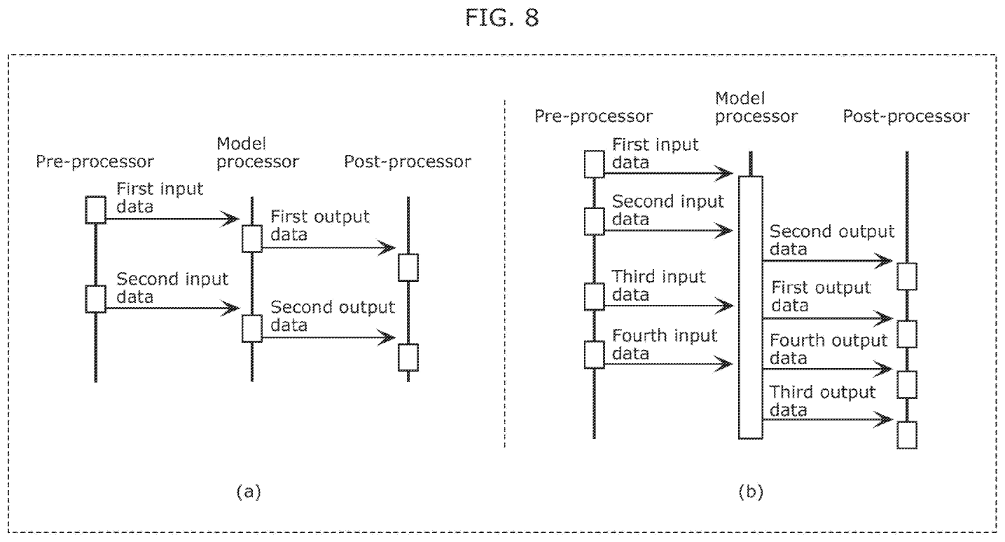

FIG. 8 is a drawing for illustrating the third processing mode. (b) of FIG. 8 illustrates one example of the processing operation of model processor 2 and post-processor 3 in the third processing mode. (a) of FIG. 8 is Comparative Example to the third processing mode, and illustrates one example of the processing operation of a system different from information processing system 10 according to the present embodiment.

In Comparative Example illustrated in (a) of FIG. 8, the pre-processor obtains pieces of input data, and sequentially outputs these pieces of input data. As a result, first input data which is a first piece of input data is input to the model processor, and then second input data which is a second piece of input data is input to the model processor. The model processor identifies the result of the prediction performed by the machine learning model for the first input data by inputting the first input data to the machine learning model, and outputs the output data indicating the result of the prediction as the first output data to the post-processor. Subsequently, the model processor identifies the result of the prediction performed by the machine learning model for the second input data by inputting the second input data to the machine learning model, and outputs the output data indicating the result of the prediction, as the second output data, to the post-processor.

Thus, in the example illustrated in (a) of FIG. 8, the first input data is input first, and thus the first output data corresponding to the first input data is output first; and the second input data is input second, and then the second output data corresponding to the second input data is output second. In other words, the output order of the pieces of output data corresponds to the input order of the pieces of input data corresponding to the pieces of output data. Thus, the model processor outputs the pieces of output data corresponding to the inputs of the pieces of input data by first in, first out (FIFO). For this reason, the attacker can easily steal combinations of input data and output data corresponding to the input data by tapping.

In contrast, in the third processing mode of information processing system 10 according to the present embodiment, as illustrated in (b) of FIG. 8, pieces of output data corresponding to pieces of input data to model processor 2 are output in an order different from the input order of the pieces of input data. The output order of the pieces of output data is randomly determined, for example.

Specifically, as illustrated in in (b) of FIG. 8, pre-processor 1 obtains the pieces of input data, and sequentially outputs the pieces of input data. For example, pre-processor 1 outputs first input data which is a first piece of input data, then outputs second input data which is a second piece of input data, then outputs third input data which a third piece of input data, and then outputs fourth input data which is a fourth piece of input data. As a result, the first input data, the second input data, the third input data, and the fourth input data are input to model processor 2 in this order.

Model processor 2 identifies the result of the prediction performed by the machine learning model for the first input data by inputting the first input data to the machine learning model. Model processor 2 identifies the result of the prediction performed by the machine learning model for the second input data by inputting the second input data to the machine learning model. After model processor 2 identifies the results of the prediction corresponding to pieces of input data whose number is equal to or greater than a threshold (e.g., 2), model processor 2 starts outputting the pieces of output data corresponding to the pieces of input data. Here, model processor 2 outputs the second output data indicating the result of the prediction performed by the machine learning model for the second input data to post-processor 3 before outputting the first output data. The first output data is the data indicating the result of the prediction performed by the machine learning model for the first input data. Subsequently, model processor 2 outputs the first output data to post-processor 3. Thus, the second output data corresponding to the second input data is output to post-processor 3 before the first output data corresponding to the first input data is output.

Similarly, model processor 2 identifies the result of the prediction performed by the machine learning model for the third input data by inputting the third input data to the machine learning model. Model processor 2 identifies the result of the prediction performed by the machine learning model for the fourth input data by inputting the fourth input data to the machine learning model. After model processor 2 identifies the results of the prediction for pieces of input data whose number is equal to or greater than a threshold (e.g., 2), model processor 2 starts outputting the pieces of output data corresponding to the pieces of input data. Here, model processor 2 outputs the fourth output data indicating the result of the prediction performed by the machine learning model for the fourth input data to post-processor 3 before outputting the third output data. The third output data is the data indicating the result of the prediction performed by the machine learning model for the third input data. Subsequently, model processor 2 outputs the third output data to post-processor 3. Thus, the fourth output data corresponding to the fourth input data is output to post-processor 3 before the third output data corresponding to the third input data is output.

Thus, in the third processing mode, the pieces of output data corresponding to the pieces of input data are output in an order different from the input order of the pieces of input data input to model processor 2. Accordingly, even when these pieces of output data are stolen by the attacker by tapping, the attacker cannot easily grasp combinations of pieces of input data and pieces of output data corresponding to the pieces of input data. In short, the results of the prediction performed by the machine learning model for the pieces of input data are hidden. As a result, the model extraction attack can be effectively suppressed.

When the pieces of output data for the first input data, the second input data, the third input data, and the fourth input data in the example illustrated in (b) of FIG. 8 are identical because these pieces of input data are identical or similar, a sufficient effect may not be obtained even if the output order of the pieces of output data is different from the input order thereof. Thus, model processor 2 may perform restriction control. In this restriction control, model processor 2 does not accept input of identical or similar pieces of input data. Alternatively, model processor 2 voids output of the pieces of output data corresponding to identical or similar pieces of input data. In other words, model processor 2 prohibits output of these pieces of output data.

In the third processing mode, the post-processing by post-processor 3 can be delayed when the output order of the pieces of output data is reordered and the above-mentioned restriction control is performed. However, when information processing system 10 is a system which allows reorder of the output order and delay of the post-processing, the above-mentioned effect by the third processing mode can be obtained. For example, model processor 2 is configured as an intrusion detection system (IDS) to determine the presence/absence of an attack such as fraudulent invasion using the machine learning model, and post-processor 3 transmits a signal to an external server, the signal indicating the result of determination about the presence/absence of the attack. In such a case, as long as the signal indicating the result of determination about the presence/absence of the attack is transmitted, some delay of the timing to transmit the signal does not cause a big problem. For this reason, the above-mentioned effect by the third processing mode can be sufficiently obtained even when model processor 2 performs the above-mentioned restriction control.

The output order of pieces of output data may be the one obtained by arbitrarily or randomly reordering the input order thereof. In the above example, at each timing when model processor 2 identifies the results of the prediction for the pieces of input data, model processor 2 starts outputting pieces of output data corresponding to the pieces of input data equal to or greater than the threshold. Here, model processor 2 may output the pieces of output data in an order different from the input order at each of the timings while model processor 2 may output the pieces of output data in an order identical to the input order at any of the timings. In other words, model processor 2 may perform processing to make the output order and the input order different from each other and processing to make the output order and the input order identical.

### [Modification of Third Processing Mode]

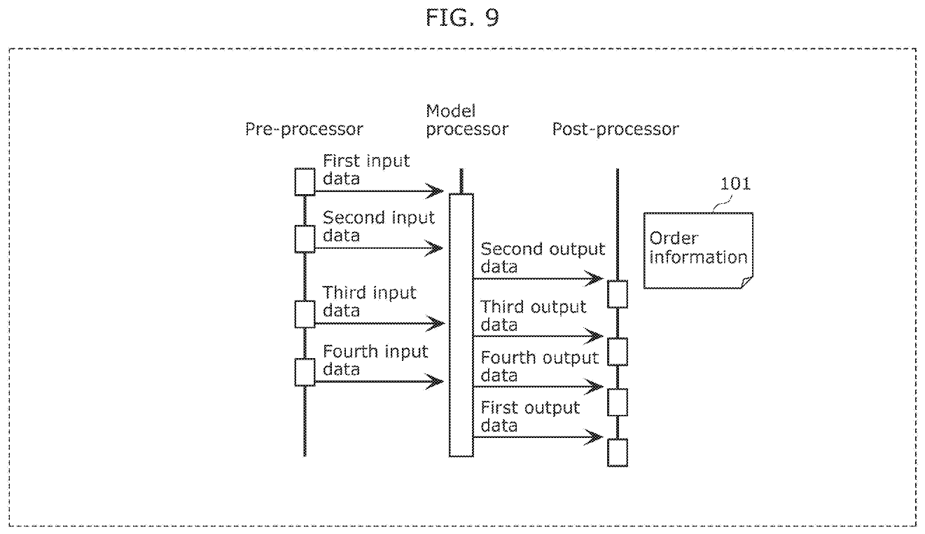

FIG. 9 is a drawing for illustrating a modification of the third processing mode.

As described above, in the third processing mode, the output order of the pieces of output data corresponding to the pieces of input data is changed from the input order of the pieces of input data. Thus, this third processing mode can be used in a system in which a big problem does not occur in the post-processing by post-processor 3 even when the order of the pieces of output data before changed is not identified by post-processor 3. On the other hand, when the order before changed is needed, model processor 2 may output order information 101 to post-processor 3 as illustrated in FIG. 9.

For example, in the example illustrated in FIG. 9, post-processor 3 obtains the second output data corresponding to the second input data, then obtains the third output data corresponding to the third input data, then obtains the fourth output data corresponding to the fourth input data, and then obtains the first output data corresponding to the first input data. When obtaining only these pieces of output data, post-processor 3 cannot identify that the second output data is the second piece of output data, the third output data is the third piece of output data, and so on. Thus, model processor 2 outputs order information 101 to post-processor 3 before outputting the first output data, the second output data, the third output data, and the fourth output data. Thereby, the order of the pieces of output data is shared by model processor 2 and post-processor 3.

Order information 101 indicates the pre-changed order of each piece of output data in the output order of outputting the pieces of output data from model processor 2 to post-processor 3. For example, in the example illustrated in FIG. 9, order information 101 indicates “second→third→fourth→first”. In other words, order information 101 indicates that the output data output first (i.e., second output data) is the pre-changed second output data corresponding to the second input data, and the output data output second (i.e., third output data) is the pre-changed third output data corresponding to the third input data.

Thereby, by reordering the pieces of output data based on order information 101, post-processor 3 can associate the order of the pieces of output data with the input order of the pieces of input data corresponding to the pieces of output data.

Thus, model processor 2 outputs order information 101 indicating the pre-changed order of each of P pieces of output data for P (where P is an integer of 2 or greater) pieces of output data continuously output, and subsequently outputs P pieces of output data in the changed order. In the above example, P=4. After outputting P pieces of output data, model processor 2 again outputs another P pieces of output data in the changed order. For example, in the example illustrated in FIG. 9, after the fourth input data is input to model processor 2, new four pieces of input data are input to model processor 2 as first input data, second input data, third input data, and fourth input data. In this case, the second output data corresponding to the new second input data is output, then the third output data corresponding to the new third input data is output, then the fourth output data corresponding to the new fourth input data is output, and then the first output data corresponding to the new first input data is output.

Thereby, pieces of output data can be reordered in the input order of the pieces of input data corresponding to the pieces of output data, and the post-processing can be appropriately performed.

In the above-mentioned example, order information 101 is shared by model processor 2 and post-processor 3 by outputting order information 101 to post-processor 3 by model processor 2. However, any processing may be performed without limiting to the above example, as long as order information 101 is shared. For example, post-processor 3 may output order information 101 to model processor 2. Alternatively, a management server or a management ECU may transmit identical order information 101 to model processor 2 and post-processor 3 at any timing, for example, during assembling of a vehicle or over-the-air (OTA) update.

### [Fourth Processing Mode]

The fourth processing mode is also called a statistical processing method. In the fourth processing mode, a smaller number of pieces of output data than the number of pieces of input data are output for the pieces of input data. In other words, when N (where N is an integer of 2 or greater) pieces of input data are obtained by pre-processor 1 and are input to model processor 2, model processor 2 identifies the result of the prediction performed by the machine learning model only for M (where M is an integer of 1 or greater and N or smaller) pieces of input data among N pieces of input data. Then, model processor 2 obtains and outputs one piece of output data based on M results of the prediction.

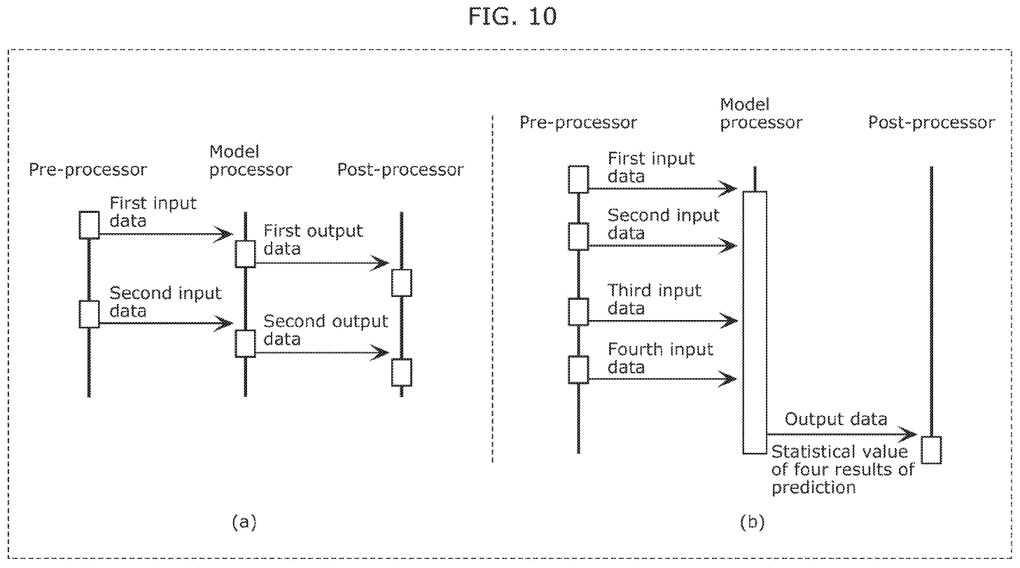

FIG. 10 is a drawing for illustrating the fourth processing mode. To be noted, (b) of FIG. 10 illustrates one example of the processing operation of model processor 2 and post-processor 3 in the fourth processing mode. (a) of FIG. 10 is Comparative Example to the fourth processing mode, and illustrates one example of the processing operation of a system different from information processing system 10 according to the present embodiment.

In Comparative Example illustrated in (a) of FIG. 10, as in the example illustrated in (a) of FIG. 8, the pre-processor obtains pieces of input data, and sequentially outputs the pieces of input data. As a result, first input data which is a first piece of input data is input to the model processor, and then, second input data which is a second piece of input data is input to the model processor. The model processor identifies the result of the prediction performed by the machine learning model for the first input data by inputting the first input data to the machine learning model, and outputs the output data indicating the result of the prediction as the first output data to the post-processor. Subsequently, the model processor identifies the result of the prediction performed by the machine learning model for the second input data by inputting the second input data to the machine learning model, and outputs the output data indicating the result of the prediction as the second output data to the post-processor.

Thus, in the example illustrated in (a) of FIG. 10, the number of pieces of input data input to model processor 2 corresponds to that of pieces of output data output from model processor 2. In such a case, the attacker can easily steal combinations of pieces of input data and pieces of output data corresponding to those of input data by tapping.

In contrast, in the fourth processing mode of information processing system 10 according to the present embodiment, as illustrated in (b) of FIG. 10, the number of pieces of input data input to model processor 2 is different from that of pieces of output data output from model processor 2.

Specifically, as illustrated in (b) of FIG. 10, pre-processor 1 obtains pieces of input data, and sequentially outputs the pieces of input data. For example, pre-processor 1 outputs first input data which is a first piece of input data, then outputs second input data which is a second piece of input data, then outputs third input data which is a third piece of input data, and then outputs fourth input data which is a fourth piece of input data. As a result, four pieces of input data, that is, the first input data, the second input data, the third input data, and the fourth input data are input to model processor 2.

Model processor 2 identifies the results of the prediction performed by the machine learning model for the four pieces of input data by inputting the first input data, the second input data, the third input data, and the fourth input data to the machine learning model. Then, after identifying the results of the prediction for the pieces of input data whose number is equal to or greater than a threshold (e.g., 4), model processor 2 starts calculating statistical values corresponding to the pieces of input data. In other words, model processor 2 calculates the statistical value of the results of the prediction of the four pieces of input data, and outputs the output data indicating the statistical value to post-processor 3. When the result of the prediction of the four pieces of input data indicates a numeric value, the statistical value may be the maximum value of the four numeric values, may be a minimum value, or may be an average or median.

In the example illustrated in (b) of FIG. 10, N=4 and M=4. In other words, when four pieces of input data are obtained by pre-processor 1 and input to model processor 2, model processor 2 identifies the results of the prediction performed by the machine learning model for the four pieces of input data. Then, model processor 2 obtains and outputs one piece of output data based on the four results of the prediction.

Thus, in the fourth processing mode, the number of pieces of input data input to model processor 2 is different from that of pieces of output data output from model processor 2. Accordingly, even when the attacker steals the output data by tapping, the attacker cannot easily grasp the combination of the input data and the output data corresponding to the input data. In other words, the result of the prediction performed by the machine learning model for the input data is hidden. As a result, the model extraction attack can be effectively suppressed.

As in the third processing mode, when the first input data, the second input data, the third input data, and the fourth input data in the example illustrated in (b) of FIG. 10 are identical or similar, a sufficient effect may not be obtained even when the number of pieces of input data input to model processor 2 is different from that of pieces of output data output from model processor 2. Thus, model processor 2 may perform restriction control. In the restriction control, model processor 2 does not accept input of identical or similar pieces of input data. Alternatively, model processor 2 voids output of pieces of output data for the identical or similar pieces of input data. In short, model processor 2 prohibits output of the pieces of output data.

In the fourth processing mode, the post-processing by post-processor 3 can be delayed when the output data indicating the statistical value is output and the above-mentioned restriction control is performed. However, when information processing system 10 is a system which allows output of the statistical value and delay of the post-processing, the above-mentioned effect by the fourth processing mode can be obtained. For example, model processor 2 is configured as an IDS, and identifies the likelihood of an attack such as fraudulent invasion, as an anomaly level, using the machine learning model, and post-processor 3 transmits a signal indicating the anomaly level to an external server. In such a case, as long as the signal indicating the statistical value of the anomaly level is transmitted, some delay of the timing to transmit the signal does not cause a big problem. For this reason, the above-mentioned effect by the fourth processing mode can be sufficiently obtained even when model processor 2 performs the above-mentioned restriction control.

### [Modification of Fourth Processing Mode]

In the example illustrated in (b) of FIG. 10, the results of the prediction performed by the machine learning model are identified for all the pieces of input data input to model processor 2. However, among the pieces of input data, at least one piece of input data need not be used in the processing by model processor 2. In short, at least one piece of input data may be neglected.

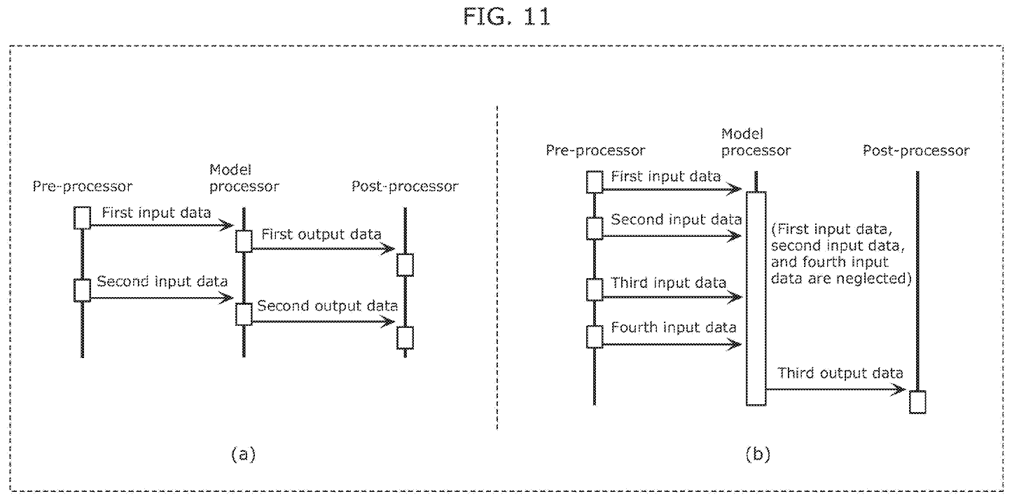

FIG. 11 is a drawing for illustrating a modification of the fourth processing mode. To be noted, (b) of FIG. 11 illustrates one example of the processing operation of model processor 2 and post-processor 3 in the modification of the fourth processing mode. (a) of FIG. 11 is Comparative Example to the modification of the fourth processing mode, and illustrates one example of the processing operation of a system different from information processing system 10 according to the present embodiment as in (a) of FIG. 10.

In the modification of the fourth processing mode, as illustrated in (b) of FIG. 11, pre-processor 1 obtains pieces of input data, and sequentially outputs the pieces of input data. For example, pre-processor 1 outputs first input data which is a first piece of input data, then outputs second input data which is a second piece of input data, then outputs third input data which is a third piece of input data, and then outputs fourth input data which is a fourth input data. As a result, four pieces of input data, i.e., the first input data, the second input data, the third input data, and the fourth input data are input to model processor 2.

Here, model processor 2 neglects the first input data, the second input data, and the fourth input data among the four pieces of input data, and identifies the result of the prediction performed by the machine learning model for the third input data by inputting only the third input data to the machine learning model. Then, model processor 2 outputs the output data indicating the result of the prediction for the third input data to post-processor 3.

In such an example illustrated in (b) of FIG. 11, N=4 and M=1. In other words, when four pieces of input data are obtained by pre-processor 1 and are input to model processor 2, model processor 2 identifies the result of the prediction performed by the machine learning model for only one piece of input data among the four pieces of input data. Then, model processor 2 obtains and outputs one piece of output data based on the result of the prediction.

Thus, even in the modification of the fourth processing mode, the number of pieces of input data input to model processor 2 is different from that of pieces of output data output from model processor 2. Accordingly, even when the attacker steals the output data by tapping, the attacker cannot easily grasp the combination of the input data and the output data corresponding to the input data. Thus, the model extraction attack can be effectively suppressed.

As above, the information processing system according to the present disclosure has been described based on the above embodiment, but the present disclosure is not limited to the embodiment. The present disclosure may also cover a variety of modifications of the embodiment conceived and made by persons skilled in the art without departing from the gist of the present disclosure.

For example, although model storage 4 stores the machine learning model in the above embodiment, it may store an AI model other than the machine learning model. Even in this case, information processing system 10 can achieve the same effects as those described above by using the AI model instead of the machine learning model.

Moreover, information processing system 10 according to the above embodiment may switch the first processing mode, the second processing mode, the third processing mode, and the fourth processing mode. In other words, information processing system 10 may select one processing mode from the first processing mode, the second processing mode, the third processing mode, and the fourth processing mode, and may operate according to the selected processing mode. Moreover, in information processing system 10, two or more processing modes of the four processing modes may be combined. Specifically, in information processing system 10, the first processing mode and the third processing mode may be combined, or the second processing mode and the fourth processing mode may be combined. In information processing system 10, the four processing modes may be combined.

In the above embodiment, the components may be configured with dedicated hardware, or may be implemented by executing software programs suitable for the components. The components may be implemented by a program executor, such as a central processing unit (CPU) or a processor, which reads out and executes software programs recorded on a recording medium such as a hard disk or a semiconductor memory.

The present disclosure also covers the following cases.
(1) At least one component is specifically a computer system configured of a microprocessor, a ROM, a RAM, a hard disk unit, a display nit, a keyboard, a mouse, and the like. The RAM or the hard disk unit stores computer programs. The microprocessor operates according to the computer programs, and thereby the at least one component achieves its function. Here, the computer programs each are configured of combinations of command codes to give instructions to a computer in order to achieve predetermined functions.
(2) Part or all of the at least one component may be configured of a single system large scale integration (LSI: large scale integrated circuit). The system LSI is an ultra multi-function LSI manufactured by integrating a plurality of constitutional portions in a single chip, and specifically, is a computer system including a microprocessor, a ROM, a RAM, and the like. The RAM stores computer programs. The microprocessor operates according to the computer programs, and thereby, the system LSI achieves its function.
(3) Part or all of the at least one component may also be configured of an IC card or a single module attachable and detachable to and from the device. The IC card or the module is a computer system configured of a microprocessor, a ROM, a RAM, and the like. The IC card or the module may also include the ultra multi-function LSI described above. The microprocessor operates according to the computer programs, and thereby, the IC card or the module achieves its function. This IC card or module may have tamper proofness.
(4) The present disclosure may be the methods described above. Moreover, the present disclosure may be computer programs for causing a computer to implement these methods, or may be digital signals configured of computer programs.

Moreover, the present disclosure may be computer programs or digital signals recorded on a computer-readable recording medium, such as a flexible disc, a hard disk, a compact disc (CD)-ROM, a DVD, a DVD-ROM, a DVD-RAM, a Blu-ray (registered trademark) disc (BD), or a semiconductor memory. Moreover, the present disclosure may be digital signals recorded on these recording media.

Moreover, the present disclosure may be computer programs or digital signals transmitted through an electrical communication line, a wireless or wired communication line, a network represented by the Internet, or data broadcasting.

Moreover, the present disclosure may be implemented by another independent computer system by recording programs or digital signals on a recording medium and transporting the recording medium or by transferring programs or digital signals through a network or the like.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2023-005580 filed on Jan. 18, 2023.

### INDUSTRIAL APPLICABILITY

The information processing system according to the present disclosure can be used in systems which monitor surroundings of the 5 vehicle, for example.

1. An information processing system provided in a vehicle, the information processing system comprising:
pre-processing circuitry that obtains input data indicating a sensing result for at least one of the vehicle, surroundings of the vehicle, or an inside of the vehicle;
model processing circuitry that obtains output data by inputting the input data to at least part of a machine learning model trained to perform prediction which is predetermined, on the sensing result, and outputs the output data; and
post-processing circuitry that obtains the output data from the model processing circuitry, and executes post-processing which is predetermined, using the output data,
wherein in a first processing mode,
the model processing circuitry:
inputs the input data to the part of the machine learning model; and
obtains data indicating a feature as the output data, the data being data output from the part of the machine learning model for the input data and being obtained in a middle of the prediction performed by the machine learning model, and
the post-processing circuitry identifies a result of the prediction performed by the machine learning model by inputting the output data to a remaining part of the machine learning model, and executes the post-processing on the result of the prediction.

2. The information processing system according to claim 1,
wherein in a second processing mode,
when pieces of input data each of which is the input data are obtained by the pre-processing circuitry,
the model processing circuitry:
inputs the pieces of input data to the machine learning model;
identifies results of the prediction performed by the machine learning model for the pieces of input data; and
obtains pieces of output data each of which is the output data, by executing labeling on the results of the prediction according to a predetermined rule,
in obtaining the pieces of output data,
when identical results of the prediction are identified for the pieces of input data, the model processing circuitry obtains the pieces of output data indicating different labels by executing the labeling on the identical results of the prediction, and
the post-processing circuitry identifies the identical results of the prediction by executing decoding according to the predetermined rule on the pieces of output data having different labels, and executes the post-processing on the identical results of the prediction.

3. The information processing system according to claim 1,
wherein in a third processing mode,
when pieces of input data obtained by the pre-processing circuitry are sequentially input to the model processing circuitry,
the model processing circuitry:
inputs the pieces of input data to the machine learning model;
identifies results of the prediction performed by the machine learning model for the pieces of input data; and
outputs pieces of output data corresponding to the pieces of input data and indicating the results of the prediction to the post-processing circuitry in an order different from an input order of the pieces of input data input to the model processing circuitry.

4. The information processing system according to claim 1,
wherein in a fourth processing mode,
when N pieces of input data are obtained by the pre-processing circuitry, and are input to the model processing circuitry, where N is an integer of 2 or greater,
the model processing circuitry:
identifies results of the prediction performed by the machine learning model for M pieces of input data among the N pieces of input data, where M is an integer of 1 or greater and N or smaller; and
obtains and outputs one piece of output data based on M results of the prediction.

5. An information processing method to be executed by a computer provided in a vehicle, the information processing method comprising:
obtaining input data indicating a sensing result for at least one of the vehicle, surroundings of the vehicle, or an inside of the vehicle;
obtaining output data by inputting the input data to at least part of a machine learning model trained to perform prediction which is predetermined, on the sensing result, and outputting the output data;
executing post-processing which is predetermined, using the output data;
in the obtaining of the output data,
inputting the input data to the part of the machine learning model; and
obtaining data indicating a feature as the output data, the data being data output from the part of the machine learning model for the input data and being obtained in a middle of the prediction performed by the machine learning model; and
in the executing of the post-processing,
identifying the result of the prediction performed by the machine learning model by inputting the output data to a remaining part of the machine learning model, and executing the post-processing on the result of the prediction.
